(19) United States
(12) Patent Application Publication
(10) Pub. No.: US 2025/0341625 A1
(43) Pub. Date: Nov. 6, 2025

(54) SYSTEM AND METHOD FOR BLUETOOTH CHANNEL SOUNDING (CS) DISTANCE ESTIMATION

(71) Applicant: Cypress Semiconductor Corporation, San Jose, CA (US)

(72) Inventors: Avik SANTRA, Irvine, CA (US); Igor KRAVETS, Lviv (UA); Nazarii KOTLIAR, Kamianka-Buzka (UA); Ashutosh PANDEY, Irvine, CA (US); Pouria ZAND, Aliso Viejo, CA (US); Claudio REY, Chandler, AZ (US); Daniel LEE, Salt Lake City, UT (US)

(73) Assignee: Cypress Semiconductor Corporation, San Jose, CA (US)

(21) Appl. No.: 18/944,866

(22) Filed: Nov. 12, 2024

Related U.S. Application Data
(60) Provisional application No. 63/641,858, filed on May 2, 2024.

(51) Int. Cl. G01S 13/10; G01S 7/285

(52) U.S. Cl. CPC G01S 13/10; G01S 7/285

(57) ABSTRACT

Techniques described here introduce a processing pipeline for range estimation in phase-based ranging (PBR) based on scene types. The processing pipeline includes a scene identifier to identify a type of channel environment in PBR. The processing pipeline includes parallel moving average spectrums for oversampling data based on the identified scene for range estimation and faster Kalman Filter estimate convergence. The processing pipeline identifies a scene to characterize a channel environment between an initiator and a reflector based on data measured during PBR. The processing pipeline generates multiple spectral representations of the data based on the scene identified to estimate the range between the initiator and the reflector. The scene is identified based on statistical properties of the data and thresholds associated with different scenes. The processing pipeline may apply MVDR beamforming technique to generate the parallel moving average spectrums using filtering parameters adaptive to the scene followed by Kalman filtering.

### CROSS REFERENCE TO RELATED APPLICATIONS

This application claims the benefit of the filing date of U.S. Provisional Application No. 63/641,858 filed on May 2, 2024 by Applicant Cypress Semiconductor Corporation, the disclosure of which is incorporated herein by reference in its entirety.

### TECHNICAL FIELD

This disclosure generally relates to technologies for positioning and ranging using wireless signals, and more particularly, to techniques to identify a type of scene of the channel environment and to sample measurement data using parallel moving average spectrums based on the identified scene for faster Kalman Filter estimate convergence to provide sub-meter accuracy and distance measurements for point-to-point wireless positioning and ranging applications using narrow-band radios such as Bluetooth technologies.

### BACKGROUND

Ranging and localization applications such as secured entry, indoor positioning, asset tracking, etc., are increasingly relying on the use of narrow-band radios such as Bluetooth Low Energy (BLE) or IEEE 802.15.4 to provide sub-meter accuracy and secure distance measurements. For example, smart tags, smart phones, smart devices, Internet-of-Things (IoT) that use short-range BLE technologies for wireless communication may use BLE radios to perform ranging and positioning of other devices. In one such technique, two devices may calculate their range (also referred to as distance) by exchanging unmodulated pulses (also known as “constant tone” in the literature) and measuring the amount of signal-phase shifts between them. To mitigate multi-path fading, the two devices may measure phase shifts over multiple frequencies to achieve an acceptable accuracy. However, it is difficult for phase-based ranging solutions using unmodulated pulses to achieve centimeter ranging accuracy in an indoor environment. In a complex and dynamic indoor environment, signal propagation path to a target may be constantly changing due to the motion of the target and geometries of the indoor space, leading to reflections, diffraction, and multipath interference of the constant tone signals. Indoor environment are also subject to high interference due to other wireless devices operating in the same frequency bands, such as WiFi. It is desired to improve the accuracy of phase-based ranging solutions in an indoor or other dynamically changing environment.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating a transmitting device transmitting unmodulated pulses to a receiving device for the receiving device to measure the phase of the received signal in a multi-carrier PBR application, in accordance with one aspect of the present disclosure;

FIG. 2 is a signaling diagram illustrating an initiator device and a reflector device synchronizing timing and exchanging constant tone signals using Bluetooth LE CS application, and for the initiator device to process phase data measured by both devices to estimate a range between the devices, in accordance with one aspect of the present disclosure;

FIG. 3 illustrates two devices exchanging unmodulated pulse signals across multiple channels and measuring the phase shifts for the devices to estimate their mutual range, in accordance with one aspect of the present disclosure;

FIG. 4 illustrates an initiator estimating the distance (also known as ranging) to a reflector based on phases measured by the initiator and the reflector for two frequency tones (e.g., channels), in accordance with one aspect of the present disclosure;

FIG. 5 illustrates a block diagram of a processing pipeline used by an initiator device of a phase-based ranging application to estimate the range to a reflector device, in accordance with one aspect of the present disclosure;

FIG. 6 illustrates a block diagram of a preprocessing module of the processing pipeline used to remove errors and ambiguities in the I/Q measurement data prior to using the data for range estimation, in accordance with one aspect of the present disclosure;

FIG. 7 illustrates a block diagram of a scene identifier module of the processing pipeline used to calculate statistics of the I/Q measurement data and to identify the scene of the operating environment, in accordance with one aspect of the present disclosure;

FIG. 8 illustrates a block diagram of a feature selection module of the processing pipeline used to adaptively adjust a bandwidth of a confidence-based bandpass filter for filtering the I/Q measurement data based on a confidence level in the data points and the identified scene, in accordance with one aspect of the present disclosure;

FIG. 9 illustrates a block diagram of a feature transformation module of the processing pipeline implementing a minimum variance distortion-less response (MVDR) algorithm to transform the bandpass filtered I/Q measurement data from the frequency domain to the time domain as a function of the identified scene, in accordance with one aspect of the present disclosure;

FIG. 10 illustrates spatial smoothing of the covariance matrix of the bandpass filtered I/Q measurement data using the MVDR transformation, in accordance with one aspect of the present disclosure;

FIG. 11 illustrates a block diagram of a spectrum generation and range estimation module used to oversample the time-domain data to generate parallel initial range estimates as a function of the identified scene, in accordance with one aspect of the present disclosure;

FIG. 12 illustrates a flow diagram of a method for operating a device to identify a scene of an environment in phase-based ranging and to generate multiple spectral representations of I/Q measurement data based on the identified scene to estimate a range to a reflector device, in accordance with one aspect of the present disclosure;

FIG. 13 illustrates a functional block diagram of two Bluetooth devices that implement phase-based ranging using channel sounding (CS) and CS post-processor of the phase measurement data to estimate a range between the two devices, in accordance with one aspect of the present disclosure.

### DETAILED DESCRIPTION

Examples of various aspects and variations of the subject technology are described herein and illustrated in the accompanying drawings. The following description is not intended to limit the invention to these embodiments, but rather to enable a person skilled in the art to make and use this invention.

Described are systems and methods for improving the accuracy of phase-based ranging and tracking application in an indoor or other dynamically changing environment using Bluetooth Low Energy (BLE), IEEE 802.15.4, or other short-range narrow-band radio technologies. One implementation of such high accuracy positioning (HAP) applications uses multi-carrier phase-based ranging for distance measurement and positioning, also referred to as multi-carrier phase difference (MCPD) (or channel sounding (CS) in BLE), in which the two-way phase difference between two devices is measured over multiple carriers. In phase-based ranging (PBR), the two devices, the initiator and the reflector, exchange multiple unmodulated pulses (UP) (also referred to as constant tones in BLE) over different carrier frequencies to mitigate multi-path fading and interference. The initiator is the device that initiates the ranging and the reflector is the device that responds to the initiator request. In applications using phase-based ranging, the initiator and the reflector may perform phase measurements on each other's UP. For example, the initiator may send the UP toward the reflector for the reflector to measure the phase of the received UP. In turn, the reflector may send back its own UP toward the initiator for the initiator to measure the phase of the received UP. At the end of the multiple UP exchanges, the initiator and the reflector may exchange their phase measurement results to estimate the range between the initiator and the reflector. In multi-carrier phase-based ranging operations, the ranging and positioning measurements may be repeated over multiple channels.

PBR applications using UP are prone to errors in an indoor or other dynamic changing environment. In such an environment, a target of the ranging application, such as people, furniture, and equipment may move, or change, affecting signal propagation of the UP. An indoor environment may also have complex geometries, e.g., walls, corners, and other obstacles made of a myriad of materials, leading to reflections, diffractions, and multipath interference of signals. An indoor environment may also be teeming with other wireless devices operating in the same frequency bands as BLE, leading to channel interference.

Conventionally, estimation of a target range may involve transforming the phase measurements from the frequency domain to the time domain using techniques such as inverse fast Fourier transform (IFFT) to identify the earliest peak as the estimated target range. Alternatively, the estimation of the target range may involve determining a slope of the distribution of the phase measurements across the multiple channels (e.g., 72 1 MHz BLE data channels in the 2.4 GHz band) using a line-fit algorithm or linear regression technique. However, the width of the peak using the IFFT technique may be too wide or the slope of the phase measurements using the line-fit algorithm may be too noisy to yield the desired range accuracy in HAP applications. These techniques also do not handle out of distribution phase measurements or other anomalies attributed to the indoor environment.

Techniques described herein introduce a BLE channel sounding (CS) processing pipeline including a scene identifier module configured to process statistical properties of the phase (or I/Q) measurement data to identify the scene (e.g., indoor with dynamic variation, indoor with low variation, outdoor, etc.). When an indoor scene is identified, a feature selection module may adaptively adjust a bandwidth of a bandpass filter used to filter the phase (or I/Q) measurement data based on a level of confidence associated with the data. The level of confidence may be based on factors such as a signal-to-noise (SNR), uncertainty in measurement techniques or feedback from a Kalman filter, a variance of recent range estimates, etc. For data points with high confidence, the bandpass filter may operate with a narrower bandwidth to allow phase (or I/Q) measurement data with the most probable frequency components to pass through, reducing the influence of noise on the range estimates. For data points with low confidence, the bandpass filter may operate with a wider bandwidth to reduce the influence of potentially unreliable filtering on the range estimates.

The CS processing pipeline may include a feature transformation module implementing a minimum variance distortion-less response (MVDR) algorithm to transform the I/Q measurement data or confidence-based bandpass filtered phase (or I/Q) measurement data from the frequency domain to the time domain as a function of the identified scene. The feature transformation module applies the MVDR algorithm normally reserved for beamforming to the domain of range estimation. A dimension of the covariance matrix of the input data may be a function of the identified scene and may be smaller than a number of frequency channels of the multi-carrier PBR. A steering vector for the MVDR may be defined for the desired range. The MVDR-based feature transformation generates a narrower peak in the time domain compared to that from IFFT technique, enabling better resolution of multipath components for detecting the closest target.

The CS processing pipeline may include a parallel moving average spectrum generation and range estimation module configured to oversample data from the MVDR-based feature transformation module for range estimation and faster Kalman Filter range estimate convergence. Multiple moving average spectrums, each one with a different smoothing factor, may generate smoothed spectral trend for range estimation. The smoothing factors may be adaptive to the identified scene, so a moving average spectrum may adapt faster to changes in the spectral trend for an indoor scene with dynamic variation. A range estimation algorithm may operate on each of the multiple moving average spectrum to estimate the respective range as a corresponding closest peak (e.g., earliest peak). The range estimation algorithm may also be a function of the identified scene. A Kalman Filter may operate on the estimated closest peaks corresponding to the multiple moving average spectrums to achieve faster convergence of the range estimates. The covariance matrix generated by the Kalman Filter representing the uncertainty in the state estimate may provide the confidence level feedback for the confidence-based bandpass filter of the feature selection module.

In one aspect, the CS processing pipeline may identify a scene characterizing a channel environment between an initiator and a reflector based on I/Q data measured by at least the initiator during phase-based ranging. The scene identifier module may compute local or global statistical properties of the I/Q data and compare the statistical properties with defined thresholds associated with different scene categories to identify the scene. The CS processing pipeline may generate multiple spectral representations of the data based on the identified scene using filtering parameters.

In one embodiment, the CS processing pipeline may determine a spectrum of the data using an MVDR beamforming algorithm based on the identified scene. The MVDR beamforming algorithm may reduce a spectral leakage of the I/Q data to generate windowed data using a windowing function. The MVDR algorithm may determine a covariance matrix of the windowed data. A dimension of the covariance matrix may be a function of the identified scene. The MVDR algorithm may filter the covariance matrix in time and in frequency (e.g., temporal and spatial smoothing) to generate filtered data. The MVDR algorithm may determine the spectrum of the data based on the filtered data and a steering vector. The steering vector may cover a maximum range between the initiator and the reflector.

The CS processing pipeline may filter the spectrum generated by the MVDR algorithm to generate multiple moving averages based on filtering coefficients associated with the multiple moving averages. The filtering coefficients may be a function of the identified scene. The CS processing pipeline may generate multiple initial estimates of the range based on the moving averages to enable faster Kalman Filter convergence of the range estimate.

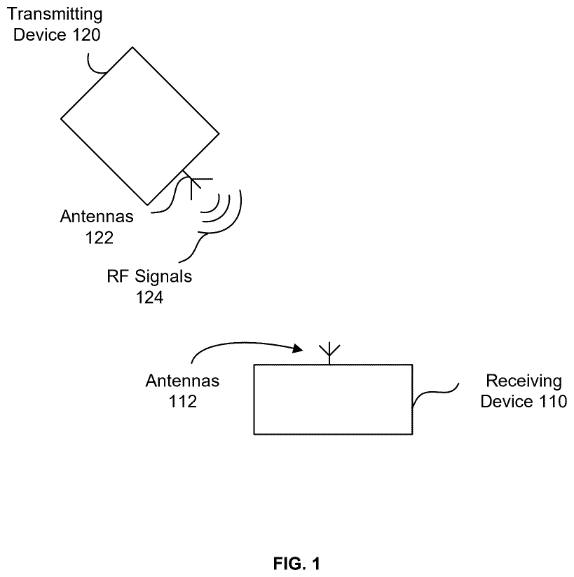

FIG. 1 is a block diagram illustrating a transmitting device transmitting unmodulated pulses (also referred to as constant tones) to a receiving device for the receiving device to measure the phase of the received signal in multi-carrier PBR, in accordance with one aspect of the present disclosure. The transmitting device 120 is shown to transmit through an antenna 122 unmodulated pulse RF signals 124 over multiple carrier frequencies. The receiving device 110 is coupled to an antennas 112 to receive the RF signals 124 to measure the phase of the received signals. The transmitting device 120 may be an initiator and the receiving device 110 may be a reflector. Conversely, the transmitting device 120 may be a reflector and the receiving device 110 may be an initiator. The reflector may be the target whose distance or range to the initiator is to be determined.

The transmitting device 120 may include circuitry to not only transmit RF signals but also to receive RF signals. Conversely, the receiving device 110 may include circuitry to not only receive RF signals but also to transmit RF signals. A phase-based ranging cycle may include multiple time-slots used by the two devices to exchange unmodulated pulses at different channels (e.g., different carrier frequencies) to estimate the distance. Each time-slot may include a receiving time interval during which a device receives an unmodulated pulse signal from the other device to measure its phase and a transmission time interval during which the first device transmits an unmodulated pulse signal for phase measurements by the other device. In each time-slot, the two devices 110 and 120 may exchange the unmodulated pulses in a different channel from the previous or the next time-slot.

The devices 110 and 120 may be connected as part of a Wireless Personal Area Network (WPAN), a Wireless Local Area Network (WLAN), or any other wireless networks. Communication protocols supported by the devices 110 and 120 may include, without limitation, Bluetooth (e.g., BLE), ZigBee, or Wi-Fi having frequencies in the Industrial, Scientific, and Medical (ISM) band. In one embodiment, the two devices may exchange 72 unmodulated pulse signals across the 80 MHz of the entire 2.4 GHz ISM band in BLE. In one embodiment, the ISM band may be at the millimeter-wave frequency such as the 60 GHz band to increase the channel bandwidth.

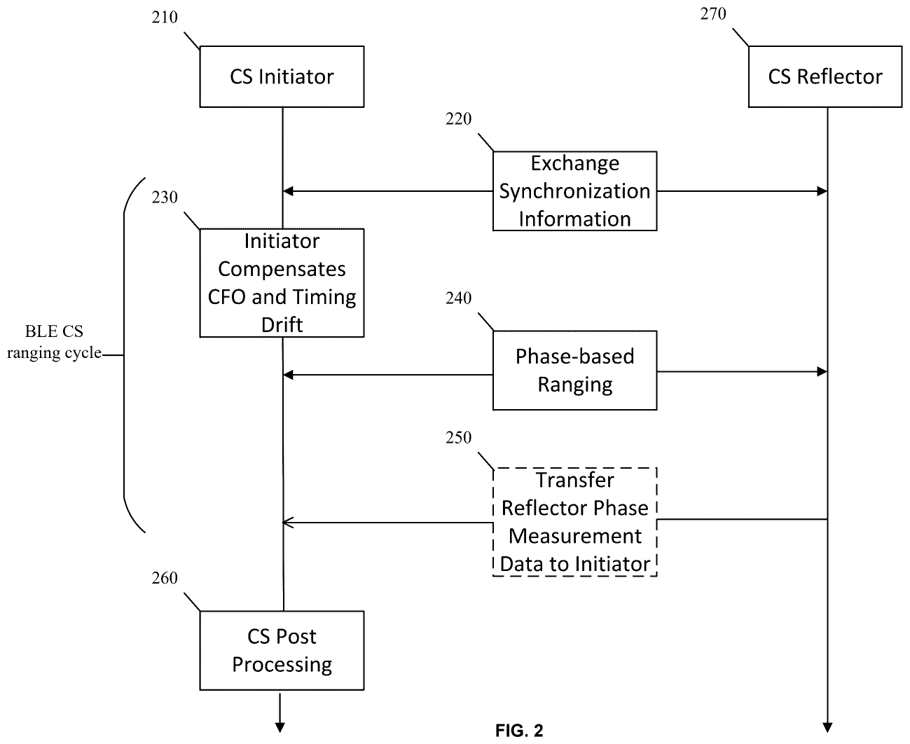

FIG. 2 is a signaling diagram illustrating an initiator device and a reflector device synchronizing timing and exchanging constant tone signals in Bluetooth LE CS application, and for the initiator device to process phase data measured by both devices to estimate a range between the devices, in accordance with one aspect of the present disclosure. A CS initiator 210 starts the BLE CS raging cycle with a CS reflector 270. The two devices exchanges constant tone signals over multiple channels to determine a wideband frequency domain transfer function of the channel.

Each ranging cycle may be divided into multiple timeslots. At the beginning of the BLE CS ranging cycle, in a calibration-synchronization timeslot, CS initiator 210 and CS reflector 270 may measure their frequency error offsets and may exchange synchronization information at operation 220 to synchronize their timing. CS initiator 210 may compensate for frequency offset and timing drift relative to CS reflector 270 at operation 230 based on the synchronization information. After the devices are time synchronized, the devices may be scheduled by a BT host to perform the constant tone (CT) exchanges in subsequent timeslots. At the beginning of each subsequent timeslot, the devices may switch to a new channel that will be used for performing the CT exchanges in the timeslot. The CT exchanges on N channels using N respective timeslots may be designated as the phase-based ranging operation 240.

For example, at a first timeslot for the CT exchange, CS initiator 210 may transmit a CT signal to CS reflector 270 on a first channel f₁. CS reflector 270 may perform phase (or I/Q) measurement on the received CT signal. The phase measurement may depend on the distance between CS initiator 210 and the CS reflector 270, and the phase difference between the reflector's local oscillator (LO) used to receive the UP signal and the initiator's LO used to transmit the UP signal. CS reflector 270 may measure a phase of Φ_{Ref}. Following this, CS reflector 270 may transmit back a CT signal to CS initiator 210 on the same channel f₁ so that CS initiator 210 may perform its phase measurement. CS initiator 210 may measure a phase of Φ_{Ini} on its received CT signal. At the end of the ranging cycle following the N timeslots for CT exchanges, CS reflector 270 may transmit its measured phase Φ_{Ref} to initiator 210 at operation 250. CS initiator 210 initiator may sum its measured phase Φ_{Ini} with the phase Φ_{Ref} measured by CS reflector 270 to generate Φ₁, which may represent the phase difference experienced by the CT signal of channel f₁ after traversing twice the distance between CS initiator 210 and CS reflector 210. In one embodiment, CS initiator 210 and CS reflector 270 can measure the input signal phase of a received CT signal in hardware and can control the output signal phase of a transmitted CT signal, referred to as inline phase correction. In such cases, CS initiator 210 and CS reflector 270 can correct their phase ambiguity automatically in hardware because the phase ambiguity will be in multiples of 2π. As such, CS reflector 270 does not transmit its measured phase Φ_{Ref} to CS initiator 210 at operation 250. CS initiator 210 directly measures the I/Q of the received CT signal to estimate the range.

At a second timeslot, CS initiator 210 and CS reflector 270 may exchange CT signals on a second channel f₂. CS reflector 270 and CS initiator 210 may respectively measure a phase on the received CT signal on channel f₂. CS reflector 270 may transmit its measured phase to CS initiator 210 at operation 250 for CS initiator 210 to sum its measured phase with the phase measured by CS reflector 270 to generate Φ₂, which may represent the phase difference experienced by the CT signal of channel f₂ after traversing twice the distance between CS initiator 210 and CS reflector 270. Similarly, at a third timeslot, CS initiator 210 and CS reflector 270 may exchange CT signals on a third channel f₃. The resulting phase difference Φ₃ may represent the phase difference experienced by the CT signal of channel f₃ after traversing twice the distance between CS initiator 210 and CS reflector 270.

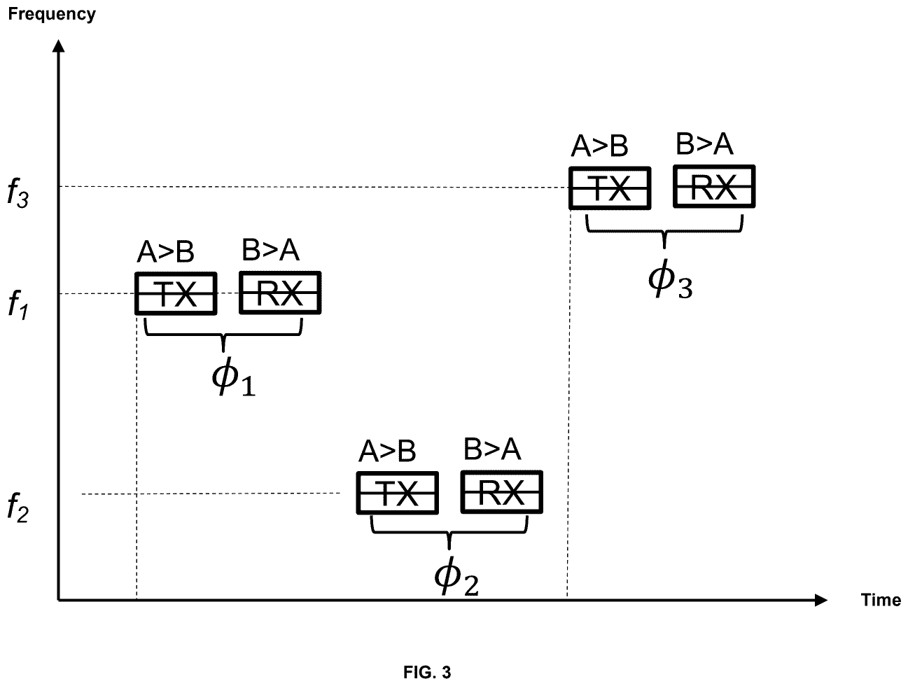

FIG. 3 illustrates two devices exchanging unmodulated pulse signals across multiple channels and measuring the phase shifts for the devices to estimate their mutual range, in accordance with one aspect of the present disclosure. Φ₁, Φ₂, and Φ₃ may represent the phase difference experienced by the CT signal of channel f₁, f₂, and f₃, respectively, after traversing twice the distance between CS initiator 210 and CS reflector 210.

Returning to FIG. 2, a CT signal on a channel k transmitted by CS initiator 210 and received by CS reflector 270 may be expressed as:

$${iq}_{R}^{k} = {α}_{R}^{k} exp ( j ( - \frac{2 π {f}^{k} D}{c} + {φ}_{I}^{k} - {φ}_{R}^{k} ) ) \qquad ( Equation 1 )$$

where

$${iq}_{R}^{k}$$

is the I/Q signal (i-phase and quadrature components of complex envelope of the RF signal) measured by CS reflector 270 (e.g., phase of

$${iq}_{R}^{k}$$

is Φ_{Ref} above);
D is the distance between CS initiator 210 and the CS reflector 270;
c is the wave propagation speed;
f^{k} is the RF frequency of channel k;

$${φ}_{I}^{k}$$

is the phase ambiguity of CS initiator 210;

$${φ}_{R}^{k}$$

is the phase ambiguity of CS reflector 270; and

$${α}_{R}^{k}$$

is the magnitude of

$${iq}_{R}^{k} .$$

A CT signal transmitted by CS reflector 270 and received by CS initiator 210 on the same channel k may be expressed as:

$${iq}_{I}^{k} = {α}_{I}^{k} exp ( j ( - \frac{2 π {f}^{k} D}{c} + {φ}_{R}^{k} - {φ}_{I}^{k} ) ) \qquad ( Equation 2 )$$

where

$${iq}_{I}^{k}$$

is the IQ signal measured by CS initiator 210 (e.g., phase of

$$i {q}_{I}^{k}$$

is Φ_{Ini} above); and

$${α}_{I}^{k}$$

is the magnitude of

$$i {q}_{I}^{k} .$$

CS initiator 210 may combine

$${q}_{R}^{k}$$

with

$$i {q}_{I}^{k}$$

to remove the phase ambiguities:

$$i {q}^{k} = {β}^{k} i {q}_{I}^{k} * i {q}_{R}^{k} = exp ( j ( - \frac{4 π {f}^{{k}_{D}}}{c} ) ) \qquad ( Equation 3 )$$

where
iq^{k} represents the change in the CT signal on channel k after traversing twice the distance D between CS initiator 210 and the CS reflector 270; and
β^{k} is the magnitude of iq^{k}.

Equation 3 has a half-wave ambiguity. To resolve the half-wavelength ambiguity, the changes in the CT signal may be measured at two distinct frequencies:

$$Δφ [ k ] = \frac{4 π Δ f [ k ] D}{c} ( mod 2 π ) \qquad ( Equation 4 )$$

where
Δφ[k] is the change in phase between the two frequencies; and
Δf is the difference between the two frequencies.

A CS post processing operation 260 may estimate distance D using the IQ measurements (Δiq[k]) from a few frequencies:

$$D = - \frac{c Δ φ [ k ]}{4 π Δ f [ k ]} ( mod \frac{c}{2 Δ f [ k ]} ) \qquad ( Equation 5 )$$

Alternatively, CS post processing operation 260 may estimate distance D using the entire set of measurements from one ranging cycle, such as averaging over the changes in I/Q measured between pairs of frequencies over all the narrow channels in Bluetooth LE (e.g., K_{f}=72):

$$D = \frac{c}{4 π Δ f [ k ]} \frac{1}{{K}_{f} - 1} {\sum }_{k = 1}^{{K}_{f} - 1} Δφ [ k ] ( mod \frac{c}{2 Δ f} ) \qquad ( Equation 6 )$$

Thus, the bandwidth may be effectively increased by a factor of 72 without reducing the range ambiguity. As a result, the range estimate may be less sensitive to phase errors.

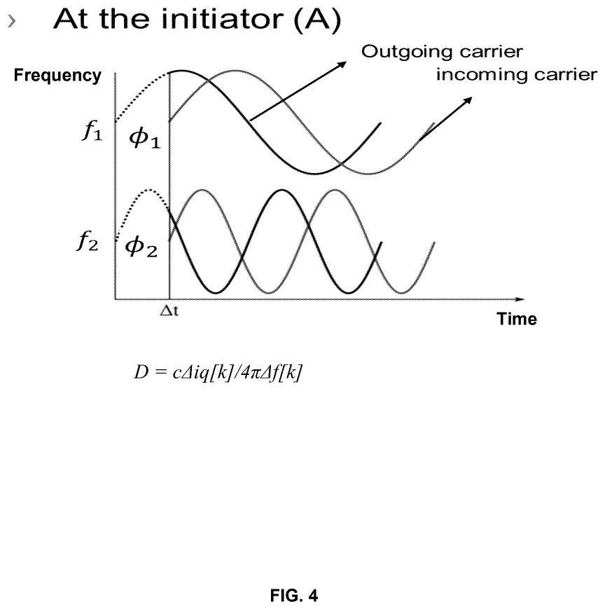

FIG. 4 illustrates CS initiator 210 estimating the distance to CS reflector 270 based on phases measured by CS initiator 210 and CS reflector 270 for two channels f¹ and f² in accordance with one aspect of the present disclosure.

Φ₁, and Φ₂ may represent the phase difference experienced by the CT signal of channel f¹ and f², respectively, after traversing twice the distance between CS initiator 210 and CS reflector 210. The distance D is estimated based on Equation 5 where Δiq[k] is the changes in I/Q between Φ₁, and Φ₂, and Δf[k] is the frequency difference between f¹ and f².

As mentioned, PBR applications using CT signals are prone to errors in an indoor or other dynamic changing environment due to target movement, changing signal propagation path, complex geometries, multipath, channel interference, etc. Disclosed is a technique for processing phase measurement data that improves the accuracy of PBR and tracking application in an dynamic indoor or other complex environment. The disclosed technique is able to learn patterns from vast amounts of phase measurement data, adapts to changing environments and reduces the need for repeated manual calibration. It includes anomaly detection to automatically handle out of distribution data to improve the accuracy of indoor location tracking. The technique uses BLE CS to illustrate its operation, but it may also be applied to other types of narrowband radios implementing PBR.

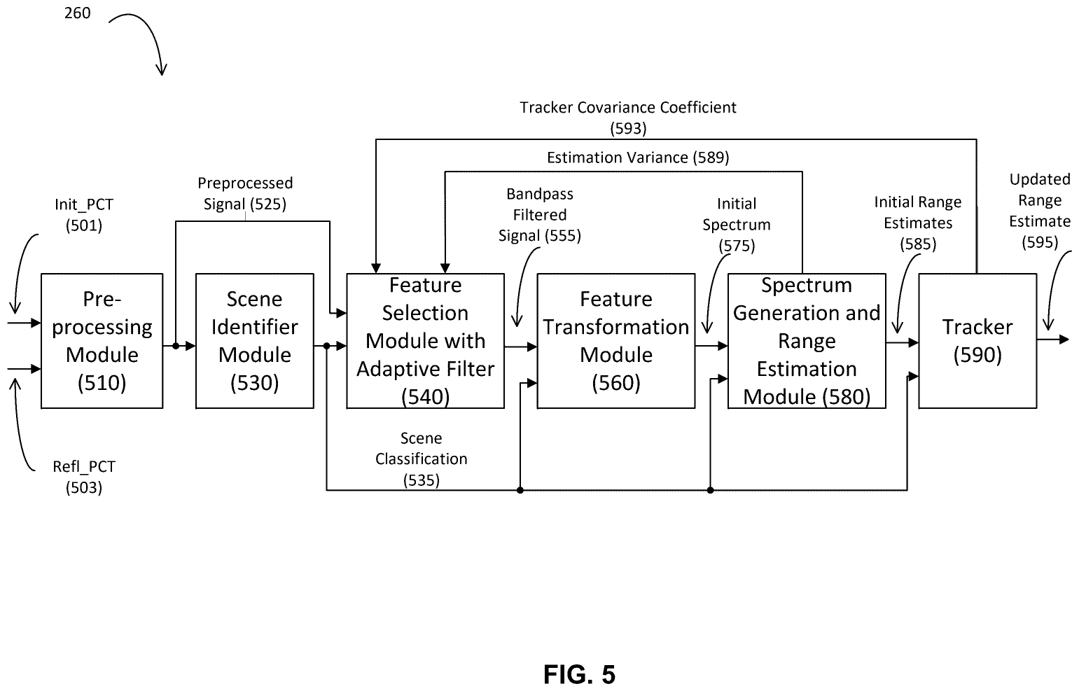

FIG. 5 illustrates a block diagram of a processing pipeline used by an initiator device of a phase-based ranging application to estimate the range to a reflector device, in accordance with one aspect of the present disclosure. The processing pipeline may be part of the CS post processing operation 260 of FIG. 2.

A preprocessing module 510 may preprocess I/Q data measured by the initiator and reflector during the CT exchanges on multiple channels to reduce artifacts introduced by the CT exchanges and other errors and/or interference in the data. The I/Q measurement data from the initiator and reflector may be designated Init_PCT 501 and Refl_PCT 503, respectively. In one embodiment, the Init_PCT 501 and Refl_PCT 503 may be divided into frames, with each frame representing the I/Q data measured over a ranging cycle of N timeslots for CT exchanges over N channels.

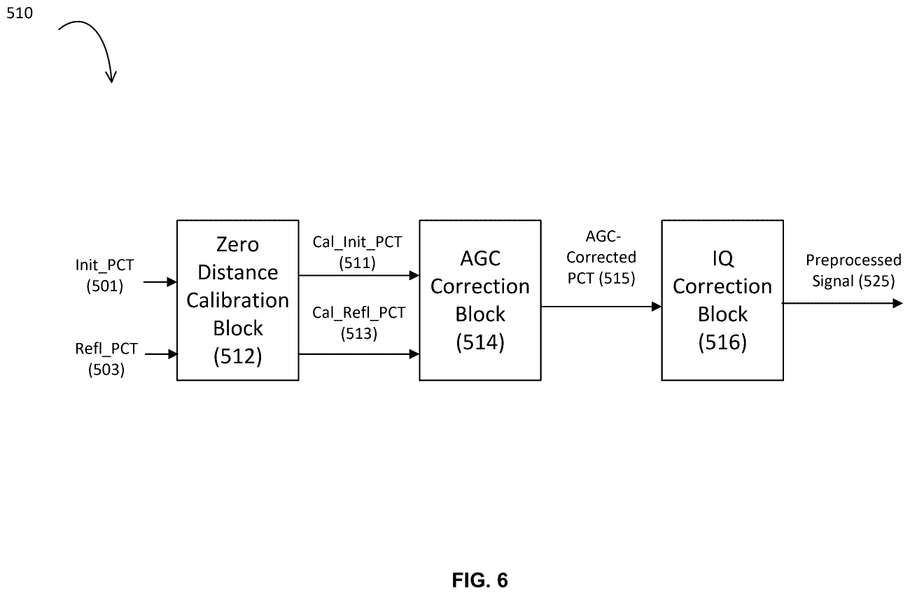

FIG. 6 illustrates a block diagram of a preprocessing module 510 used to remove errors and ambiguities in the I/Q measurement data prior to using the data for range estimation, in accordance with one aspect of the present disclosure. The preprocessing module 510 includes a zero distance calibration block 512, an AGC correction block 514, and an IQ correction block 516.

Zero distance calibration block 512 may be configured to process Init_PCT 501 and Refl_PCT 503 to negate errors introduced by the antennas and any analog front-end (AFE) effects of the initiator and reflector. For example, errors in the measurement data due to antenna transfer function tolerance and device-to-device tolerance of the AFE of the initiator and reflector may be mitigated or reduced. In one embodiment, zero-distance calibration block 512 may perform calibration by putting initiator and reflector close to each other, such as in a clean environment (e.g., anechoic chamber) or in a multipoint setup when a clean environment is not available. I/Q measurement data generated during the calibration stage may be preprocessed, such as filtered, corrected for automatic gain control (AGC) changes, and denoised to obtain PCT calibration value.

During a PCT normalization stage, Init_PCT 501 and Refl_PCT 503 from the CT exchanges may be normalized using the PCT calibration value. In one embodiment, the calibration stage may determine a bias that includes a distance offset and a phase offset. Init_PCT 501 and Refl_PCT 503 from the CT exchanges may shift its respective I/Q by the phase offset to generate Cal_Init_PCT 511 and Cal_Refl_PCT 513, respectively. The processing pipeline may compensate for the distance offset by subtracting the distance offset from a an initial distance estimate when estimating the range.

AGC correction block 514 may correct for changes in the amplification of the CT signals when the initiator or reflector collects the I/Q data at different ranging cycles of the multi-channel CT exchanges. AGC correction block 514 may recalculate the magnitude of the PCT data measured by the initiator and reflector to compensate for the changes in the amplification so the processing pipeline may combine and process PCT data measured at different time for a channel.

In one embodiment, AGC correction block 514 may apply AGC correction to the Cal_Init_PCT 511 and Cal_Refl_PCT 513 to compensate for the AGC gain used to collect the I/Q measurement data by the following equations:

$$TableGainsMag = db 2 mag ( - TableGainDb ) \qquad ( Equation 7 )$$

$$Δ {iq}_{a g {c}_{-} c o r r}^{init} [ k ] = Δ i {q}^{init} [ k ] * T a b l e G a i n s Mag ( Init\_Gain + 1 ) \qquad ( Equation 8 )$$

$$Δ {iq}_{agc\_corr}^{refl} [ k ] = Δ i {q}^{refl} [ k ] * T a b l e G a i n s M a g ( Refl\_Gain + 1 ) \qquad ( Equation 9 )$$

where:
TableGainsMag is a function that converts an input gain from dB to magnitude;
Δiq^{init}[k] is the Cal_Init_PCT 511 for channel k;
Init_Gain is the AGC gain of the initiator when it performs the I/Q measurements at a particular timeslot for Init_PCT 501;

$$Δ i {q}_{agc\_corr}^{init} [ k ]$$

is the Δiq^{init}[k] corrected for Init_Gain;
Δiq^{refl}[k] is the Cal_Refl_PCT 513 for channel k;
Refl_Gain is the AGC gain of the reflector when it performs the I/Q measurements at a particular timeslot for Refl_PCT 503; and

$$Δ i {q}_{agc\_corr}^{refl} [ k ]$$

is the Δiq^{refl}[k] corrected for Refl_Gain.

In another embodiment, AGC correction block 514 may apply AGC correction to the Cal_Init_PCT 511 and Cal_Refl_PCT 513 to compensate for the AGC gain used to collect the I/Q measurement data by the following equations:

$$Δ {iq}_{agc\_corr}^{init} [ k ] = Δ {iq}^{init} [ k ] * {\sqrt{2}}^{( - Init\_Gain )} \qquad ( Equation 10 )$$

$$Δ {iq}_{agc\_corr}^{refl} [ k ] = Δ i {q}^{refl} [ k ] * {\sqrt{2}}^{( - {Refl}_{G a i n} )} \qquad ( Equation 11 )$$

In another embodiment, AGC correction block 514 may apply AGC correction to the combined PCT derived from calibrated initiator PCT 511 and calibrated reflector PCT 513 by the following equations:

$$Δ i q [ k ] = Δ {iq}^{init} [ k ] * Δ {iq}^{refl} [ k ] \qquad ( Equation 12 )$$

$$Δ {iq}_{agc\_corr} [ k ] = Δ i q [ k ] * {\sqrt{2}}^{( - Init\_Gain - Refl\_Gain )} \qquad ( Equation 13 )$$

where
Δiq[k] is the combined Δiq^{init}[k] and Δiq^{refl}[k] (also referred to as residual PCT or Res-PCT) for channel k (see Equation 4); and
Δiq_{agc_corr}[k] is the Δiq[k] corrected for Init_Gain and Refl_Gain.

In one embodiment, AGC correction block 514 may apply AGC correction to thresholds and weights used for combining and processing the I/Q measurement data over the different ranging cycles of the multi-channel CT exchanges. For example, a measurement verification component of the AGC correction block 514 may compare the sum of the power of the combined PCT (e.g., Res_PCT) for a channel against a threshold to identify and exclude from further processing any outlier data. If the sum of the power of the combined PCT for a channel is less than the threshold, the combined PCT for the channel is ignored. AGC correction block 514 may generate AGC-corrected PCT 515 as an output.

An IQ correction block 516 may correct for phase ambiguity in the I/Q measurement data due to Doppler frequency, co-channel interference, and two-sided communication of the CT exchanges. IQ correction block 516 may operate on the AGC-corrected PCT 515 received from AGC correction block 514 or other I/Q measurements in the processing pipeline. IQ correction block 516 may generate preprocessed signal 525 as an output of the preprocessing module 510.

In one embodiment, IQ correction block 516 may reduce distance error due to phase ambiguity because the PCT data with respect to a moving target are not measured at the same time for all channels. A velocity correction sub-block may compensate for the phase offset due to target motion by:

$$Δ i {q}_{vel\_corr} [ k ] = Δ i q [ k ] * {e}^{j * vel\_comp} \qquad ( Equation 14 )$$

$$vel\_comp = 2 π * f * ( t 1 - t 2 ) * v / c \qquad ( Equation 15 )$$

where
Δiq[k] may be the Res_PCT for channel k or the AGC-corrected PCT 515 for channel k;
Δiq_{vel_corr}[k] is Δiq[k] corrected for the phase offset due to target motion;
vel_comp is the phase offset:
f is the frequency of the CT signal for channel k;
(t1−t2) is the delay between PCT measurements;
t1 is the start measurement time (e.g., of the ranging cycle)
t2 is the PCT measurement time at frequency f; and
v is the Doppler velocity between the initiator and reflector.

In one embodiment, IQ correction block 516 may reduce or cancel co-channel interference such as Wi-Fi interference. A channel interference cancellation sub-block may measure a quality factor of the I/Q measurement data to identify any interference signal. In one embodiment, the channel interference cancellation sub-block may identify an interference signal when the magnitude of Res_PCT is greater than an interference threshold. The channel interference cancellation sub-block may correct for the interference signal by weighting Res_PCT as a function of the quality factor or interpolating the I/Q measurement data in the frequency or time domain using techniques such as linear interpolation, cubic interpolation, or through neural networks.

In one embodiment, IQ correction block 516 may filter the I/Q measurement data using a low pass filter to reduce side lobes and noise. The bandwidth or order of the low pass filter may be tunable. The low pass filter may smooth the Res_PCT to remove strong multipath signal that is too far away.

In one embodiment, IQ correction block 516 may remove ghost lobes that appear due to two-sided communication between the initiator and reflector and are combinations of true lobes. A ghost lobes removal sub-block may determine a square root of Res_PCT. The ghost lobes removal sub-block may recover true lobes from ambiguity in the I/Q measurement data by:

$$s 1 = \vert \sqrt{Δ iq [ idx ]} - \sqrt{Δ iq [ idx - 1 ]} \vert \qquad ( Equation 16 )$$

$$s 2 = \vert \sqrt{Δ iq [ idx ]} * {e}^{j * π} - \sqrt{Δ iq [ idx - 1 ]} \vert \qquad ( Equation 17 )$$

$$S = min ( s 1 , s 2 )$$

$$iq [ idx ] = \{ \begin{matrix}Δ iq [ idx ] if S = s 1 \\ Δ iq [ idx ] * {e}^{j * π} if S = s 2\end{matrix} \qquad ( Equation 18 )$$

### Where

Δiq[idx] is the Res_PCT of the current ranging cycle or frame for a channel; and
Δiq[idx−1] is the Res_PCT of the previous ranging cycle or frame for a channel.

Returning to FIG. 5, a scene identification module 530 may process statistical properties of the preprocessed signal 525 to identify the scene (e.g., indoor with dynamic variation, indoor with low variation, outdoor, etc.). The identified scene may be used to set the processing pipeline. For example, algorithmic parameters of the processing pipeline may be tuned or optimized based on the identified scene to improve the accuracy of PBR in an indoor environment.

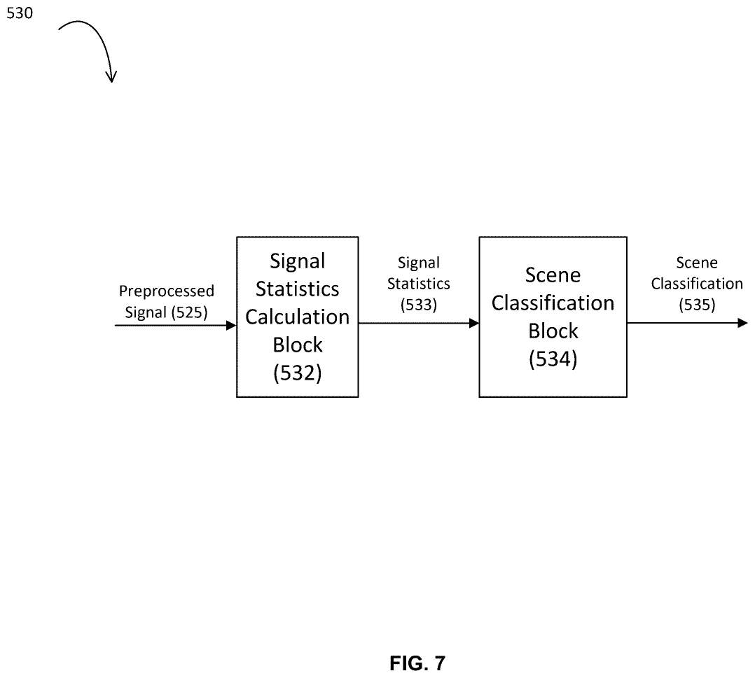

FIG. 7 illustrates a block diagram of a scene identifier module 530 used to calculate statistics of the I/Q measurement data and to identify the scene of the operating environment, in accordance with one aspect of the present disclosure. Scene identifier module 530 may include a signal statistics calculation block 532 and a scene classification block 534.

Signal statistics calculation block 532 may calculate local statistical properties of the preprocessed signal 525 (e.g., preprocessed Res_PCT) received from preprocessing module 510. In one embodiment, signal statistics calculation block 532 may fit a first order polynomial to the preprocessed data 525 of a ranging cycle to calculate a mean square error (MSE). The first order polynomial may approximate a slope of the distribution of the I/Q measurements across the multiple channels of the ranging cycle. The MSE may capture the variability of the I/Q measurements around the slope. In one embodiment, signal statistics calculation block 532 may calculate the mean of the magnitude of preprocessed data 525 within a window to capture the average magnitude of the I/Q measurements (or average distance value in the time domain) within the window. The window may span across one or multiple channels of a ranging cycle. In one embodiment, signal statistics calculation block 532 may calculate the standard deviation of the magnitude of preprocessed data 525 within a window to capture the variability of the magnitude of the I/Q measurements around the mean within the window.

In one aspect, signal statistics calculation block 532 may calculate global statistical properties of the preprocessed data 525 based on the local statistics. In one embodiment, signal statistics calculation block 532 may calculate the mean and/or the standard deviation of the MSE across multiple ranging cycles. In one embodiment, signal statistics calculation blocks 532 may calculate the mean of the local means across windows to determine a global average magnitude of the I/Q measurements. In one embodiment, signal statistical calculation block 532 may calculate the standard deviation of the local means across windows to determine a global variability of the local means. In one embodiment, signal statistical calculation block 532 may calculate a mean of the local standard deviations to determine a global average of the standard deviation of the magnitude of the I/Q measurements. The local statistical properties and/or the global statistical properties may be output as signal statistics 533.

Scene classification block 534 may define or characterize thresholds to be compared against the signal statistics 533 based on empirical observations or domain knowledge of the statistical properties associated with different scene types (i.e., indoor vs. outdoor scene). In one embodiment, there may be multiple thresholds associated with different scene categories. For example, an indoor scene with dynamic variation may be associated with defined thresholds for one or more of MSE, local mean, local standard deviation, mean of MSE, standard deviation of MSE, mean of local means, standard deviation of local means, mean of local standard deviation, etc. Scene classification block 534 may analyze signal statistics 533 and compare them to the defined thresholds. An indoor scene with low variation or an outdoor scene may have a different set of defined thresholds. Based on which thresholds are crossed, scene classification block 534 may classify the scene into a category for output as scene classification 535. Scene classification 535 may be used to tune parameters or select algorithm in the signal processing pipeline.

Returning to FIG. 5, a feature selection module with adaptive filter 540 may adaptively adjust a bandwidth of a bandpass filter used to filter preprocessed signal 525 based on a level of confidence associated with the data points and scene classification 535. For example, when scene classification 535 indicates an indoor scene, the bandwidth of the bandpass filter may be modulated by a confidence estimate of the data points. In one embodiment, the confidence estimate may be based on the signal-to-noise ratio (SNR) of the data points. A higher SNR may indicate higher confidence in the data points. In one embodiment, the confidence estimate may be uncertainty in the measurement techniques such as a tracker covariance coefficient 593 from a tracker module 590. In one embodiment, tracker covariance coefficient 593 may be the covariance matrix representing uncertainty in the state estimate from a Kalman filter. Higher values in the elements of the covariance matrix may indicate lower confidence in the range estimate. In one embodiment, the confidence estimate may be other variability measure of the data points such as the MSE, local standard deviation, standard deviation of local means, mean of local standard deviation, etc., calculated by scene identifier module 530. In one embodiment, the confidence estimate may be an estimation variance 589 of range estimates from a spectrum generation and range estimation module 580.

The confidence-based bandpass filter may allow frequency components within a desired range to pass through while attending other. For example, for data points with high confidence, the bandpass filter operates with a narrower bandwidth to allow a smaller range of frequencies around the expected signal to pass through. The narrower bandwidth focuses on the most likely signal components and reduces the influence of out-of-band interference, reflections, or noise to improve the accuracy of the estimated range as confidence increases. For data points with low confidence, the bandpass filter operates with a wider bandwidth to reduce the influence of potentially unreliable filtering on the final estimates. The wider bandwidth captures a potential change in the true signal (e.g., target moved) to prevent the filter from attenuating the new desired signal components.

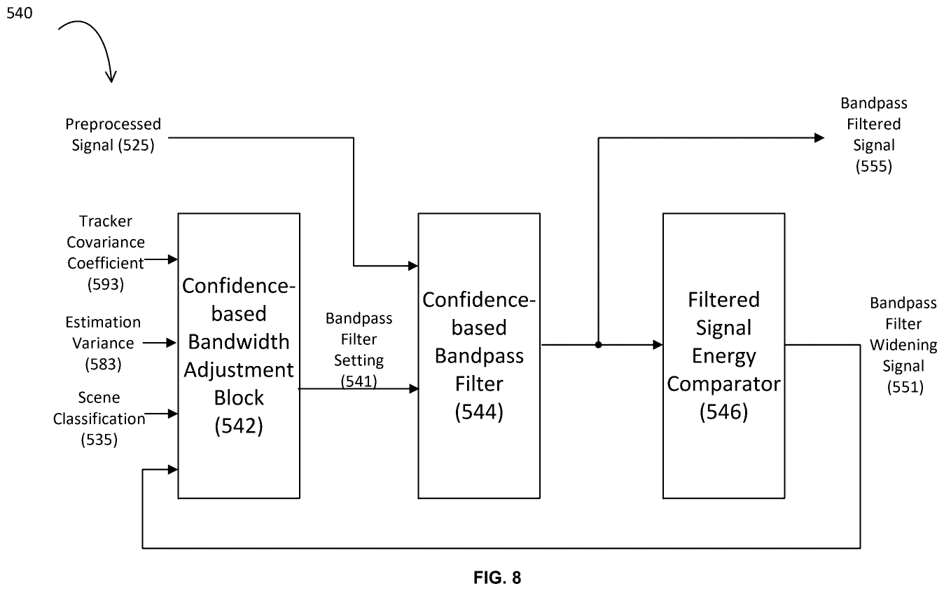

FIG. 8 illustrates a block diagram of a feature selection module with adaptive filter 540 used to adaptively adjust a bandwidth of a confidence-based bandpass filter for filtering the I/Q measurement data based on a confidence level in the data points and the identified scene, in accordance with one aspect of the present disclosure. Feature selection module with adaptive filter 540 may include a confidence-based bandwidth adjustment block 542, a confidence-based bandpass filter 544, and a filtered signal energy comparator 546.

Confidence-based bandwidth adjustment block 542 may adjust the bandwidth of the passband filter based on tracker covariance coefficient 593 when scene classification 535 indicates an indoor scene. The tracker covariance coefficient 593 may be a covariance matrix generated by a tracker module 590, such as a Kalman filter. The Kalman filter processes measurement data to provide an estimate of the range (e.g., target distance) and its associated covariance. The covariance matrix may represent the uncertainty in the estimate of the Kalman filter based on the data points. A smaller covariance indicates higher confidence in the estimate and may be the result of more measurement data giving rise to the same range estimate. Confidence-based bandwidth adjustment block 542 may gradually narrow the filter bandwidth (e.g., stop frequencies) closer to the ideal or original design values. The narrower bandwidth allows a smaller range of frequency components around the expected signal to pass through. The bandpass filter thus focuses on the most likely signal components and reduces the influence of out-of-band interference, reflections, or noise on the data points. In one embodiment, adjusting the stop frequencies based on tracker covariance coefficient 593 may involve pre-defined relationship or dynamic calculations.

However, the filter bandwidth may not shrink beyond a minimum frequency limit (e.g., 0.2 m in range equivalent around the expected signal). In one embodiment, the minimum frequency limit may be set based on the refresh rate of the estimate provided by the Kalman filter and a maximum speed of initiator and reflector movement. The minimum frequency limit allows the center frequency of the bandpass filter to be adjusted in either direction (target moving closer or away) due to movement of the initiator and reflector.

Confidence-based bandwidth adjustment block 542 may provide bandpass filter setting 541 to confidence-based bandpass filter 544. Confidence-based bandpass filter 544 may filter preprocessed signal 525 (e.g., preprocessed Res_PCT) based on bandpass filter setting 541 to generate bandpass filtered signal 555.

In one embodiment, a threshold is set for the energy of bandpass filtered signal 555. Filtered signal energy comparator 546 may calculate the energy of bandpass filtered signal 555 and compare the filtered energy against the threshold. If the filtered energy falls below the threshold, it may indicate a potential change in the true signal, for example when the target moved. In this case, filtered signal energy comparator 546 may generate a bandpass filter widening signal 551 to indicate confidence-based bandwidth adjustment block 542 to widen the bandwidth. The broader frequency range allows confidence-based bandpass filter 544 to capture potentially changing signal and mitigating the influence of potentially unreliable data. The threshold-based bandwidth widening allows confidence-based bandpass filter 544 to adapt to changes in the true signal, preventing excessive filtering when the target moves. In one embodiment, the threshold for the bandpass filtered signal 555 may be determined based on the application and noise characteristics.

In one embodiment, confidence-based bandwidth adjustment block 542 may adjust the bandwidth of confidence-based bandpass filter 544 based on estimation variance 589 of range estimates when scene classification 535 indicates an indoor scene. In one embodiment, a spectrum generation and range estimation module 580 of the processing pipeline may estimate a current estimation variance 589 based on the range estimate derived from the current frame or ranging cycle of data. Confidence-based bandwidth adjustment block 542 may compare the current estimation variance 589 with previous estimation variance based on the range estimate derived from one or more previous frames of data. If the current estimation variance 589 is decreasing from the previous estimation variance, there is higher confidence in the range estimate. It may also signify a more stable and consistent signal. In this case, confidence-based bandwidth adjustment block 542 may narrow the filter bandwidth to allow a more precise selection of signal frequency components to pass through.

Otherwise, if the current estimation variance 589 is increasing from the previous estimation variance, there is less confidence in the range estimate. If the filtered energy of bandpass filtered signal 555 is also below the above-described filtered energy threshold, indicating a potential change in the true signal (e.g., target moved), confidence-based bandwidth adjustment block 542 may increase its bandwidth to capture the potentially changing signal components and mitigate the influence of potentially unreliable data.

Returning to FIG. 5, a feature transformation module 560 may implement a minimum variance distortion-less response (MVDR) algorithm to transform bandpass filtered signal 555 from the frequency domain to the time domain as a function of the identified scene. The MVDR algorithm is an adaptive beamforming technique that seeks to minimize the output power from an antenna array while maintaining a unity gain toward a desired signal direction defined by a steering vector. Feature transformation module 560 applies the MVDR beamforming algorithm to the domain of range estimation to find the spectrum with the dominant frequency at a desired range defined by a steering vector. The MVDR-based technique generates a narrower peak in the time domain than an IFFT-based technique, allowing finer resolution of multipath components to detect the target as the closest peak.

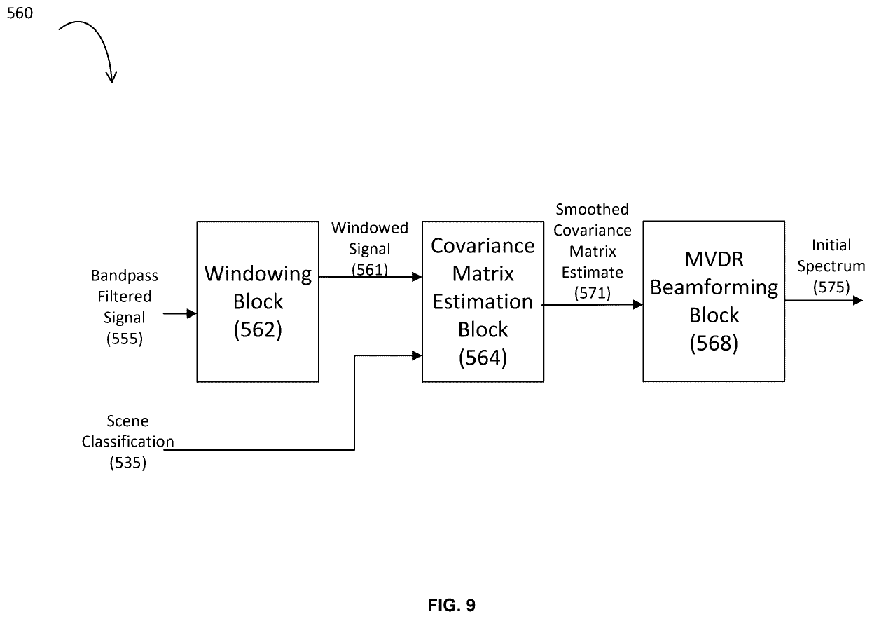

FIG. 9 illustrates a block diagram of a feature transformation module 560 of the processing pipeline implementing a MVDR algorithm to transform the bandpass filtered I/Q measurement data from the frequency domain to the time domain as a function of the identified scene, in accordance with one aspect of the present disclosure. Feature transformation module 560 may include a windowing block 562, a covariance matrix estimation block 564, and a MVDR beamforming block 568.

Window block 562 may apply a window function to bandpass filtered signal 555 to reduce spectral leakage such as to eliminate sidelobes. In one embodiment, the window function may be a Hann window based on the operation:

$$( Equation 19 )$$

$$w ( n ) = 0.5 * ( 1 - cos ( 2 π n / ( M - 1 ) ) ) for n = 0 , 1 , … , ( M - 1 )$$

$$Δ {iq}_{w} [ n ] = Δ iq [ n ] * w ( n ) \qquad ( Equation 20 )$$

where
w(n) is the Hann window function;
Δiq[n] is the bandpass filtered signal 555 (e.g., bandpass filtered Res_PCT) for a channel; and
Δiq_{w}[n] is the output windowed signal 561.

Covariance matrix estimation block 564 may construct the covariance matrix of windowed signal 561 using the operation:

$$( Equation 21 )$$

$${R}_{xx ( n )} = α * {R}_{xx ( n - 1 )} + ( 1 - α ) * \frac{1}{( N - M + 1 )} {\sum }_{i = 1}^{N - M + 1} Δ {iq}_{w} ( i : i + M - 1 ) Δ {{iq}_{w} ( i : i + M - 1 )}^{H}$$

where
Δiq_{w}(i:i+M−1)Δiq_{w}(i:i+M−1)^{H} is the covariance matrix of Δiq_{w}[n];
Rₓₓ₍ₙ₎ is the smoothed covariance matrix of Δiq_{w}[n] (e.g., based on current frame of I/Q data);
Rₓₓ₍ₙ₋₁₎ is the smoothed covariance matrix of Δiq_{w}[n] (e.g., based on previous frame of I/Q data);
α is a temporal smoothing factor;
N is the number of frequency channels;
M is the dimension of the covariance matrix Rₓₓ where M<N; and
H is the Hermitian transpose operation.

Equation 21 shows that the covariance matrix is temporally smoothed using the temporal smoothing factor α. The lower the α, the more emphasis is placed on the current covariance matrix of x_{w}(n) and less emphasis on the older covariance matrix. In one embodiment, Rₓₓ₍ₙ₎ (or simply Rₓₓ) may be an average of the covariance matrix over time. In one embodiment, temporal smoothing of the covariance matrix may be implemented in two passes in a forward-backward manner. In a first pass, temporal smoothing may be implemented using a forward-looking version of the I/Q measurement data such as based on equation 21. In a second pass, temporal smoothing may be implemented using the time-reversed (backward) version of the same I/Q measurement data.

Equation 21 shows that the covariance matrix is also spatially smoothed based on:

$$\frac{1}{( N - M + 1 )} {\sum }_{i = 1}^{N - M + 1} Δ {iq}_{w} ( i : i + M - 1 ) Δ {{iq}_{w} ( i : i + M - 1 )}^{H} \qquad ( Equation 22 )$$

Spatial smoothing spatially averages the M×M covariance matrix over the range of N frequency channels. In one embodiment, M is a function of the scene. For example, M may be higher if scene classification 535 indicates an indoor scene compared to an outdoor scene (e.g., M=42 if scene classification 535 indicates an indoor scene; and M=16 for an outdoor scene).

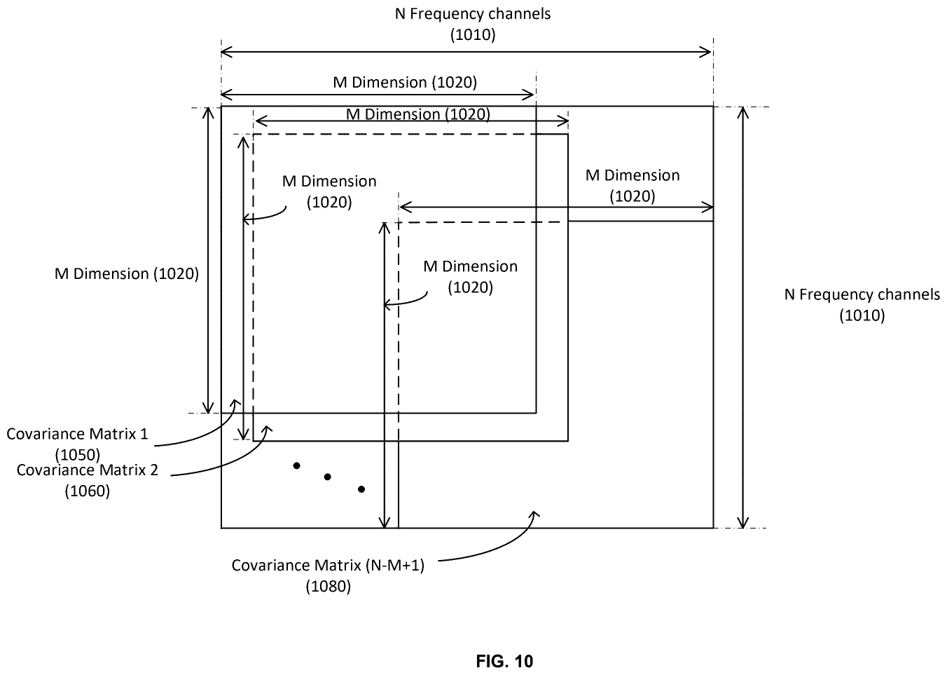

FIG. 10 illustrates spatial smoothing of the covariance matrix of the bandpass filtered I/Q measurement data using the MVDR transformation, in accordance with one aspect of the present disclosure. The dimension M (1020) of a covariance matrix is less than the N frequency channels (1010). Covariance matrix 1 (1050) may be x_{w}(1:M)x_{w}(1:M)^{H}; covariance matrix 2 (1060) may be x_{w}(2:M+1)x_{w}(2:M+1)^{H} . . . and covariance matrix (N−M+1) (1080) may be x_{w}(N−M+1:N)x_{w}(N−M+1:N)^{H}. Each covariance matrix is spatially offset by one frequency channel from the nearest covariance matrix. As shown, there are (N−M+) covariance matrices to cover the range of N frequency channels (1010).

Returning to FIG. 9, MVDR beamforming block 568 may calculate an initial spectrum 575 of the bandpass filtered signal 555 based on the smoothed covariance matrix estimate 571 and a steering vector. MVDR beamforming block 568 may attempt to minimize the power of initial spectrum 575 while determining the dominant frequency in a range defined by the steering vector.

In one embodiment, the steering vector may be expressed as:

$$w ( θ ) = [ 1 , {e}^{- j 2 π θ Δ f} , {e}^{- j 2 π θ ( 2 * Δ f )} , {e}^{- j 2 π θ ( ( N - 1 ) * Δ f )} ] \qquad ( Equation 23 )$$

where
w(θ) is the steering vector for the desired range θ;
N is the number of frequency channels; and
Δf is the width of each frequency channel.

MVDR beamforming block 568 may calculate the MVDR output at the range θ∈[0, Rₘₐₓ] based on:

$$P ( θ ) = \frac{{w}^{H} ( θ ) w ( θ )}{{w}^{H} ( θ ) {R}_{xx}^{- 1} w ( θ )} \qquad ( Equation 24 )$$

where
Rₘₐₓ is the maximum range;
P(θ) is the MVDR output;
w(θ) is the steering vector of Equation 23; and

$${R}_{x x}^{- 1}$$

is the inverse of Rₓₓ₍ₙ₎ of Equation 21.
   MVDR beamforming block 568 may output P(θ) as initial spectrum 575.

Returning to FIG. 5, a spectrum generation and range estimation module 580 may process initial spectrum 575 generated by the MVDR transformation to generate parallel moving average spectrum for range estimation and faster Kalman filter estimate convergence. Multiple moving average spectrums, each one with a different smoothing factor, may generate smoothed spectral trend for range estimation. The smoothing factors may be adaptive to the identified scene, so a moving average spectrum may adapt faster to changes in the spectral trend for an indoor scene with dynamic variation. A range estimation algorithm may operate on each of the multiple moving average spectrum to estimate the respective range as a corresponding closest peak (e.g., earliest peak). The range estimation algorithm may also be adaptive to the identified scene.

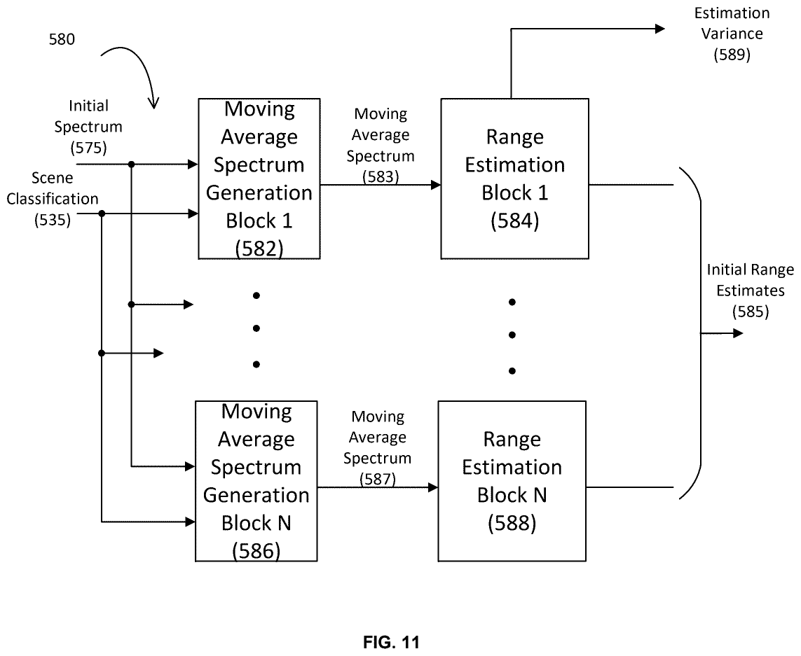

FIG. 11 illustrates a block diagram of a spectrum generation and range estimation module 580 used to oversample the time-domain data to generate parallel initial range estimates as a function of the identified scene, in accordance with one aspect of the present disclosure. Spectrum generation and range estimation module 580 may include N parallel moving average spectrum generation blocks 1 (582) . . . N (586) and corresponding N parallel range estimation blocks 1 (584) . . . N (588).

Each moving average spectrum generation block (582 . . . 586) may generate a corresponding moving average spectrum (583 . . . 587) to represent a smoothed spectral trend of initial spectrum 575 using a corresponding one of N smoothing factors (α₁, α₂ . . . α_{N}). The moving average spectrum Sₘ(θ) may be initialized as:

$${S}_{0} ( θ ) = {P}_{0} ( θ ) \qquad ( Equation 25 )$$

where
S₀(θ) is the initial moving average spectrum at time step 0; and
P₀(θ) is the P(θ) of Equation 24 (initial spectrum 575) at time step 0.

At each new time step t, each moving average spectrum generation block (582 . . . 586) may update its moving average spectrum Sₘ(θ) based on the current spectrum P(θ). The updating of the moving average spectrum Sₘ(θ) may be expressed as:

$${S}_{t}^{i} ( θ ) = {α}_{i} {P}_{t} ( θ ) + ( 1 - {α}_{i} ) {S}_{t - 1}^{i} ( θ ) \qquad ( Equation 26 )$$

where

$${S}_{t}^{i} ( θ )$$

is the moving average spectrum Sₘ(θ) at time step t for moving average spectrum generation block i;
αᵢ is the smoothing factor for moving average spectrum generation block i;
Pₜ(θ) is the P(θ) at time step t; and

$${S}_{t - 1}^{i} ( θ )$$

is the moving average spectrum Sₘ(θ) at time step (t−1) for moving average spectrum generation block i.

In one embodiment, the smoothing factor αᵢ may be adaptively determined based on the scene type (scene classification 535). A higher αᵢ gives more weight to the current spectrum Pₜ(θ), resulting in a faster adaptation of the moving average spectrum. For example, an indoor scene with dynamic variation may configure a αᵢ≈1. Conversely, a lower αᵢ gives more weight to past spectrum (e.g., previous moving average spectrum

$${S}_{t - 1}^{i} ( θ ) ) ,$$

leading to a slower adaptation of the moving average spectrum. In one embodiment, the N smoothing factors (α₁, α₂ . . . α_{N}) for the N parallel moving average spectrum generation blocks 1 (582) . . . N (586) may be different. The moving average spectrum

$${S}_{t}^{i} ( θ )$$

represents the smoothed spectral trend of P(θ) at time step t for moving average spectrum generation block i.

The N parallel range estimation blocks 1 (584) . . . N (588) may calculate initial range estimates 585 based on the N corresponding moving average spectrum

$${S}_{t}^{i} ( θ )$$

(moving average spectrum (583 . . . 587)). In one embodiment, each range estimation block may initialize an empty list of candidate peaks for storing range indices of candidate time-domain peaks. A range index for a candidate peak may represent an estimated range of the candidate peak. Each range estimation block may loop through its moving average spectrum

$${S}_{t}^{i} ( θ )$$

to search for one or more candidate peaks. If the a point on the moving average spectrum

$${S}_{c}^{i} ( θ )$$

is greater than its neighbors on the left and on the right, and the point is greater than a predefined threshold, a range estimation block may add the range index of the point as an candidate peak to its list.

After a loop through the moving average spectrum

$${S}_{c}^{i} ( θ ) ,$$

the list of candidate peaks may store the range indices for one or more candidate peaks. The candidate peaks may represent signal peaks of a direct path component or multipath components. A range estimation block may select the range index for a first element in its list of candidate peaks (e.g., a candidate peak with the smallest range index representing the direct path component) as the current closest peak index. The range estimation block may determine if the current closest peak index is greater than a specific range. In one embodiment, the specific range may be set at 3 m. In one embodiment, if the current closest peak index is greater than the specific range and if scene classification 535 indicates an indoor scene, the range estimation block may use the current closest peak index to find the range index of a point 1.5 dB down to the left (closer in range) of the candidate peak corresponding to the current closest peak index. The range estimation block may update the current closest peak index with this newly found range index. The range estimation block may report the current closest peak index as its initial range estimate (585). The N parallel range estimation blocks 1 (584) . . . N (588) may report N initial range estimates 585 based on the N corresponding moving average spectrum

$${S}_{c}^{i} ( θ ) .$$

In one embodiment, the N parallel range estimation blocks 1 (584) . . . N (588) may update N initial range estimates 585 for every frame (e.g., ranging cycle) of I/Q measurement data. In one embodiment, one of the range estimation blocks (e.g., range estimation block 1 (584)) may determine a variance of its reported initial range estimates 585 from the multiple frames of I/Q measurement data. The variance of initial range estimate 585 may be output as estimation variance 589. In one embodiment, estimation variance 589 may be determined based on a variance of initial range estimates 585 reported by the N parallel range estimation blocks 1 (584) . . . N (588). As discussed, feature selection module with adaptive filter 540 may use estimation variance 589 as a measure of the level confidence associated with the I/Q measurement data to adjust the bandwidth of the confidence-based bandpass filter.

Returning to FIG. 5, a tracker module 590 may be a Kalman filter that processes N initial range estimates 585 from N parallel range estimation blocks 1 (584) . . . N (588) of spectrum generation and range estimation module 580 to achieve faster convergence of the range estimates. The Kalman filter may output the state covariance matrix as tracker covariance coefficient 593 to represent the uncertainty in the state estimate. As discussed, tracker covariance coefficient 593 may provide the confidence level feedback for the confidence-based bandpass filter to adjust its bandwidth.

The Kalman filter for range estimates may have a state vector x containing two or three elements. A state vector containing two elements may be represented as:

$$= {[ h \dot{h} ]}^{T} \qquad ( Equation 27 )$$

A state vector containing three elements may be expressed as:

$$x = {[ h \dot{h} \ddot{h} ]}^{T} \qquad ( Equation 28 )$$

where
x is the state vector;
h is the target position (range value);
\dot{h} is the target velocity; and
\ddot{h} is the target acceleration;

The state vector with two elements may assume a constant velocity model to describe how the state evolves over time. The constant velocity model may be represented by the state transition matrix A:

$$A = [ \begin{matrix}1 & Δ t \\ 0 & 1\end{matrix} ] \qquad ( Equation 29 )$$

where
Δt is the time step between measurements (e.g., time step between initial range estimates (585))

The state vector with three elements may assume a constant acceleration model to describe how the state evolves over time. The constant acceleration model may be represented by the state transition matrix A:

$$A = [ \begin{matrix}1 & Δ t & 0.5 Δ {t}^{2} \\ 0 & 0 & Δ t \\ 0 & 0 & 1\end{matrix} ] \qquad ( Equation 30 )$$

The Kalman filter may predict the current state vector \hat{x}ₖ based on the estimated state vector xₖ₋₁ for the previous state and the state transition matrix A before receiving a new measurement:

$${\hat{x}}_{k} = {Ax}_{k - 1} \qquad ( Equation 31 )$$

where
\hat{x}ₖ is the current predicted state vector; and
xₖ₋₁ is the previous estimated state vector.

The Kalman filter may estimate a covariance matrix Pₖ₋₁ to represent the uncertainty in the previous state estimate xₖ₋₁. Kalman filter may propagate estimated covariance matrix Pₖ₋₁ to predict the covariance matrix \hat{P}ₖ for the current state estimate xₖ based on:

$${\hat{P}}_{k} = {AP}_{k - 1} {A}^{H} + Q \qquad ( Equation 32 )$$

where
\hat{P}ₖ is the current predicted covariance matrix;
Pₖ₋₁ is the previous estimated covariance matrix; and
Q is a process noise covariance matrix that accounts for the uncertainty in the state transition model.

The Kalman filter may predict the target position based on the current state \hat{x}ₖ and a measurement matrix H based on:

$${\hat{y}}_{k} = H {\hat{x}}_{k} \qquad ( Equation 33 )$$

where
ŷₖ is the predicted target position; and
H is the measurement matrix, which may be [1 0] for a state vector with two elements, or may be [1 0 0] for a state vector with three elements, indicating that the target position may be directly measured.

When a new measurement (e.g., initial range estimate 585) is received, the Kalman filter may calculate the difference between the new measurement and the predicted target position, also referred to as the innovation, based on:

$${v}_{k} = {z}_{k} - {\hat{y}}_{k} \qquad ( Equation 34 )$$

where
vₖ is the difference (innovation); and
zₖ is the new range measurement.

The Kalman filter may also update its state when a new measurement is received. For example, the Kalman filter may update a Kalman gain Kₖ to determine how much weight to give to the new measurement relative to the predicted state based on:

$${K}_{k} = {\hat{P}}_{k} {{H}^{H} ( H {\hat{P}}_{k} {H}^{H} + R )}^{- 1} \qquad ( Equation 35 )$$

where
\hat{P}ₖ is the predicted covariance matrix for the current state (Equation 32)
H is the measurement matrix; and
R is the measurement noise covariance matrix representing the uncertainty in the measurements.

The Kalman filter may update an estimate of the state vector with the new measurement using the Kalman gain Kₖ based on:

$${x}_{k} = {\hat{x}}_{k} + {K}_{k} {v}_{k} \qquad ( Equation 36 )$$

where
xₖ is the current estimated state vector;
\hat{x}ₖ is the current predicted state vector (Equation 31); and
vₖ is the innovation (Equation 34).

The Kalman filter may also update an estimate of the covariance matrix to reflect the reduced uncertainty after incorporating the new measurement:

$${P}_{k} = ( I - {K}_{k} H ) {\hat{P}}_{k} \qquad ( Equation 37 )$$

where
Pₖ is the current estimated covariance matrix; and

\hat{P}ₖ is the current predicted covariance matrix (Equation 32).

In one embodiment, Kalman filter may determine whether to update the Kalman filter state based on whether the innovation vₖ is within a gating window. An ellipsoidal gating function may check if innovation vₖ is within the gating window. If it is outside the ellipsoidal gating window, then the new measurement data is deemed an outlier and the Kalman filter may not update the Kalman gain K, the current estimated state vector xₖ, and the current estimated covariance matrix Pₖ. Otherwise, the Kalman filter state is updated as in equations 35, 36, and 37. The checking of whether the innovation vₖ is within a gating window may be expressed as:

$${v}_{k}^{T} {\hat{P}}_{k}^{- 1} {v}_{k} < γ \qquad ( Equation 38 )$$

where
γ is the gating window.
   In one embodiment, the gating function may be configured based on the scene classification 535. In one embodiment, when scene classification 535 indicates an indoor scene indicates an indoor scene with dynamic variation, gating window y may be larger because new measurement data may have more variance compared to that of an outdoor scene.

The Kalman filter may generate the tracker covariance coefficient 593 as Pₖ(1,1) for the confidence-based bandpass filter to adjust its bandwidth. Feature selection module with adaptive filter 540 may progressively narrow its bandwidth as the estimated covariance matrix Pₖ from the Kalman filter decreases (level of confidence in the estimated state vector xₖ increases) as a result of more range measurements being at the same target distance.

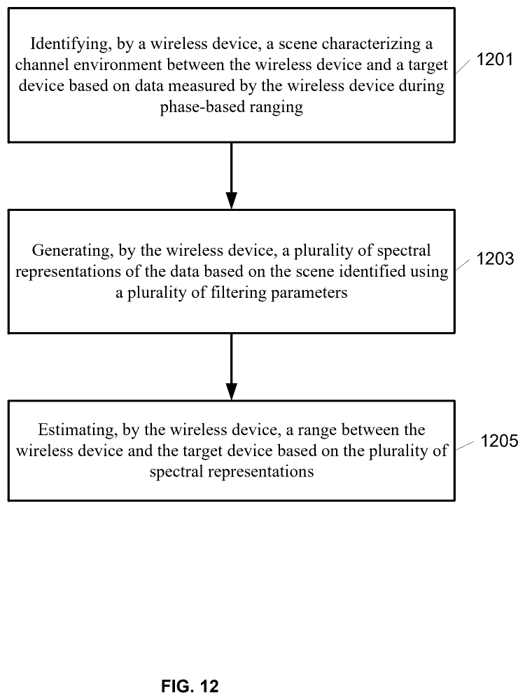

FIG. 12 illustrates a flow diagram of a method 1200 for operating a device to identify a scene of an environment in phase-based ranging and to generate multiple spectral representations of I/Q measurement data based on the identified scene to estimate a range to a reflector device, in accordance with one aspect of the present disclosure. In one aspect, method 1200 may be performed by a wireless device such as CS initiator 210 of FIG. 2 utilizing hardware, software, or combinations of hardware and software.

In operation 1201, the wireless device may identify a scene characterizing a channel environment between the wireless device and a target device based on data measured by the wireless device during phase-based ranging.

In operation 1203, the wireless device may generate multiple spectral representations of the data based on the scene identified using multiple filtering parameters.

In operation 1205, the wireless device may estimate a range between the wireless device and the target device based on the multiple spectral representations.

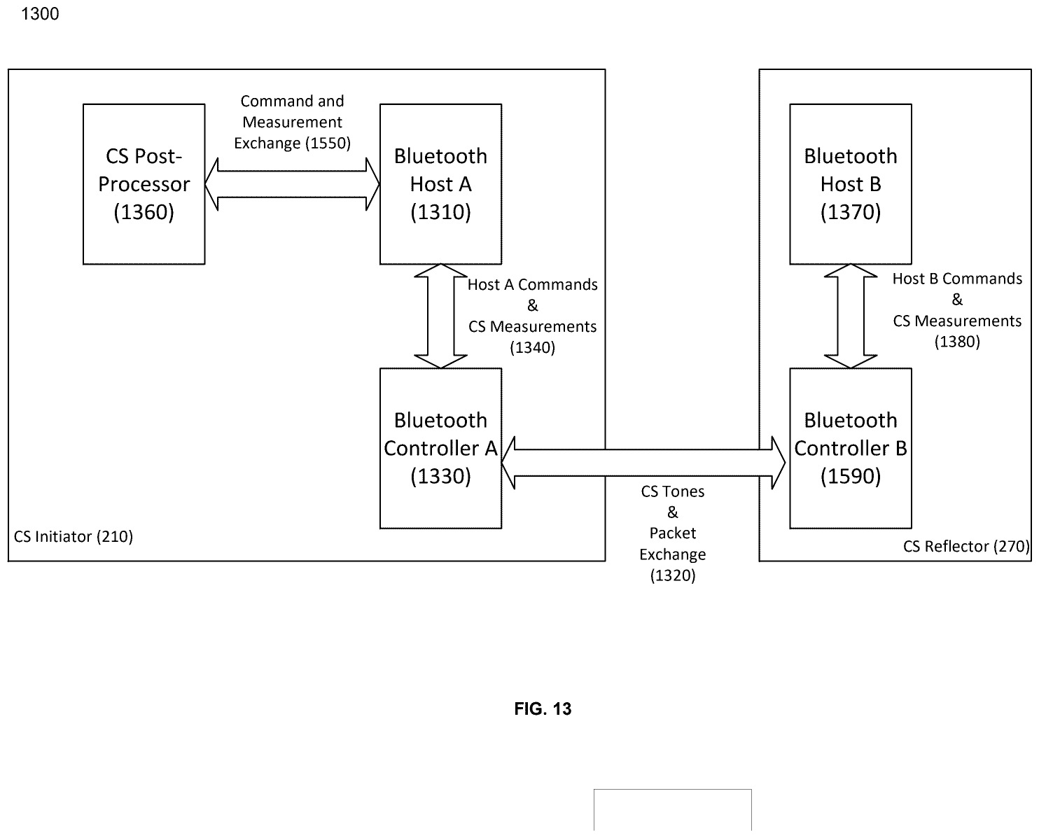

FIG. 13 illustrates a functional block diagram of two Bluetooth devices 210 and 270 that implement phase-based ranging using channel sounding (CS) and CS post-processing of the phase measurement data to estimate a range between the two devices, in accordance with one aspect of the present disclosure.

A CS initiator 210 may have a Bluetooth controller A 1330, a Bluetooth host A 1310, and a CS post-processor 1360. A CS reflector 270 may have a Bluetooth controller B 1390 and a Bluetooth host B 1370. Bluetooth controller A 1330 and Bluetooth controller B 1390 may exchange constant tones and packets on multiple channel frequencies 1320 in a ranging cycle using a channel shuffling mechanism. In one embodiment, the two device may exchange 72 constant tone signals across the 80 MHz of the entire 2.4 GHz ISM band in BLE to determine a wideband frequency transfer function of the channel. Bluetooth controller B 1390 may transmit its measured phase of the received constant tone signals to Bluetooth controller A 1330.

Bluetooth controller A 1330 may receive host commands from Bluetooth host A 1310 through an initiator communication interface 1340 to perform the operations of the ranging cycle. Similarly, Bluetooth controller B 1390 may receive host commands from Bluetooth host B 1370 through a reflector communication interface 1380 to perform the ranging cycle operations. Bluetooth controller B 1390 may transmit its phase measurements to its Bluetooth host B 1370 through reflector communication interface 1380 for processing such as during the calibration-synchronization timeslot. Bluetooth controller A 1330 may transmit its phase measurements and the phase measurements received from Bluetooth controller B 1390 to Bluetooth host A 1310 through initiator communication channel 1340 for processing. Bluetooth host A 1310 may process the phase measurements exchanged during the ranging cycle to estimate the range or may invoke CS post-processor 1360 to process the phase measurements. Bluetooth host A 1310 or CS post-processor 1360 may process the phase measurements as described for operations of FIGS. 5-14 utilizing hardware, software, or combinations of hardware and software.

Various embodiments of the multi-carrier phase-based ranging system described herein may include various operations. These operations may be performed and/or controlled by hardware components, digital hardware and/or firmware/programmable registers (e.g., as implemented in computer-readable medium), and/or combinations thereof. For example, the operations may be performed by a general-purpose computer or a processing system executing computer program stored in a computer-readable medium. The methods and illustrative examples described herein are not inherently related to any particular device or other apparatus. Various systems (e.g., such as a wireless device operating in a near or long field environment, pico area network, wide area network, etc.) may be used in accordance with the teachings described herein, or it may prove convenient to construct more specialized apparatus to perform the required method steps. The required structure for a variety of these systems will appear as set forth in the description above.

A computer-readable medium used to implement operations of various aspects of the disclosure may be non-transitory computer-readable storage medium that may include, but is not limited to, electromagnetic storage medium, magneto-optical storage medium, read-only memory (ROM), random-access memory (RAM), erasable programmable memory (e.g., EPROM and EEPROM), flash memory, or another now-known or later-developed non-transitory type of medium that is suitable for storing configuration information.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “may include”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing. For example, certain operations may be performed, at least in part, in a reverse order, concurrently and/or in parallel with other operations.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by firmware (e.g., an FPGA) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of operations by a wireless device, comprising:
identifying a scene characterizing a channel environment between the wireless device and a target device based on data measured by the wireless device during phase-based ranging;
generating a plurality of spectral representations of the data based on the scene identified using a plurality of filtering parameters; and
estimating a range between the wireless device and the target device based on the plurality of spectral representations.

2. The method of claim 1, wherein identifying a scene comprises:
calculating statistical properties of the data; and
classifying a scene category based on the statistical properties of the data and thresholds associated with a plurality of scene categories.

3. The method of claim 2, wherein calculating statistical properties of the data comprises calculating one or more of:
a local mean square error (MSE) of the data with respect to a linear approximation fit of the data within a first time window;
a local mean of the data within the first time window; or
a local standard deviation of the data with respect to the local mean within the first time window.

4. The method of claim 3, wherein calculating the statistical properties of the data further comprises calculating one or more of:
a mean of a plurality of the local MSE across a second time window;
a standard deviation of a plurality of the local MSE across the second time window;
a mean of a plurality of the local means across the second time window;
a global standard deviation of a plurality of the local means across the second time window; or
a mean of the local standard deviations across the second time window, wherein the second time window includes a plurality of the first time windows.

5. The method of claim 2, wherein classifying a scene category comprises:
comparing the statistical properties of the data with the thresholds; and
identifying one scene category of the plurality of scene categories in response to the statistical properties crossing one or more thresholds associated with the scene category.

6. The method of claim 1, wherein the scene comprises one of an indoor scene with one or more levels of variations in the channel environment or an outdoor scene.

7. The method of claim 1, wherein generating a plurality of spectral representations of the data comprises:
determining a spectrum of the data using a minimum variance distortion-less response (MVDR) beamforming algorithm based on the scene identified.

8. The method of claim 7, wherein determining the spectrum of the data comprises:
reducing a spectral leakage of the data to generate windowed data, wherein the data comprises data measured on a plurality of frequencies of the phase-based ranging;
determining a covariance matrix of the windowed data, wherein a dimension of the covariance matrix is adaptive to the scene identified;
filtering the covariance matrix in time and in frequency to generate filtered data; and
determining the spectrum of the data based on the filtered data and a steering vector, wherein the steering vector covers a maximum range between the wireless device and the target device.

9. The method of claim 7, wherein generating a plurality of spectral representations of the data further comprises:
filtering the spectrum to generate a plurality of moving averages of the spectrum based on a filtering coefficient corresponding to each of the plurality of moving averages, wherein one or more of the filtering coefficients are adaptive to the scene identified; and
generating a plurality of initial estimates of the range based on the plurality of moving averages.

10. The method of claim 9, wherein estimating a range comprises:
estimating the range based on the plurality of initial estimates of the range using a Kalman filter.

11. An apparatus comprising:
a processing system configured to:
identify a scene characterizing a channel environment between the apparatus and a target device based on data measured by the apparatus during phase-based ranging;
generate a plurality of spectral representations of the data based on the scene identified using a plurality of filtering parameters; and
estimate a range between the apparatus and the target device based on the plurality of spectral representations.

12. The apparatus of claim 11, wherein to identify a scene, the processing system is configured to:
calculate statistical properties of the data; and
classify a scene category based on the statistical properties of the data and thresholds associated with a plurality of scene categories.

13. The apparatus of claim 12, wherein to calculate statistical properties of the data, the processing system is configured to calculate one or more of:
a local mean square error (MSE) of the data with respect to a linear approximation fit of the data within a first time window;
a local mean of the data within the first time window; or
a local standard deviation of the data with respect to the local mean within the first time window.

14. The apparatus of claim 13, wherein to calculate statistical properties of the data, the processing system is further configured to calculate one or more of:
a mean of a plurality of the local MSE across a second time window;
a standard deviation of a plurality of the local MSE across the second time window;
a mean of a plurality of the local means across the second time window;
a global standard deviation of a plurality of the local means across the second time window; or
a mean of the local standard deviations across the second time window, wherein the second time window includes a plurality of the first time windows.

15. The apparatus of claim 12, wherein to classify a scene category, the processing systems is configured to:
compare the statistical properties of the data with the thresholds; and
identify one scene category of the plurality of scene categories in response to the statistical properties cross one or more thresholds associated with the scene category.

16. The apparatus of claim 11, wherein the scene comprises one of an indoor scene with one or more levels of variations in the channel environment or an outdoor scene.

17. The apparatus of claim 11, wherein to generate a plurality of spectral representations of the data, the processing system is configured to:
determine a spectrum of the data using a minimum variance distortion-less response (MVDR) beamforming algorithm based on the scene identified.

18. The apparatus of claim 17, wherein to determine a spectrum of the data, the processing system is configured to:
reduce a spectral leakage of the data to generate windowed data, wherein the data comprises data measured on a plurality of frequencies of the phase-based ranging;
determine a covariance matrix of the windowed data, wherein a dimension of the covariance matrix is adaptive to the scene identified;
filter the covariance matrix in time and in frequency to generate filtered data; and
determine the spectrum of the data based on the filtered data and a steering vector, wherein the steering vector covers a maximum range between the apparatus and the target device.

19. The apparatus of claim 17, wherein to generate a plurality of spectral representations of the data, the processing system is configured to:
filter the spectrum to generate a plurality of moving averages of the spectrum based on a filtering coefficient corresponding to each of the plurality of moving averages, wherein one or more of the filtering coefficients are adaptive to the scene identified; and
generate a plurality of initial estimates of the range based on the plurality of moving averages.

20. A system comprising:
a host device;
an initiator device configured to exchange ranging signals with a reflector device in phase-based ranging (PBR) to obtain measurement data; and
a processing system configured to:
identify a scene characterizing a channel environment between the initiator device and the reflector device based on measurement data;
generate a plurality of spectral representations of the measurement data based on the scene identified using a plurality of filtering parameters; and
estimate a range between the initiator device and the reflector device based on the plurality of spectral representations.
